(19) United States
(12) Patent Application Publication
(10) Pub. No.: US 2013/0017364 A1
(43) Pub. Date: Jan. 17, 2013

(54) RESIN COMPOSITION AND COMPOSITE MADE BY SAME

(71) Applicants: Hsin-Pei CHANG, Tu-Cheng (TW); Jun-yi WANG, Shenzhen City (CN); Xue-Peng LI, Shenzhen City (CN); Ming-Hsu LU, Tu-Cheng (TW)

(72) Inventors: Hsin-Pei CHANG, Tu-Cheng (TW); Jun-yi WANG, Shenzhen City (CN); Xue-Peng LI, Shenzhen City (CN); Ming-Hsu LU, Tu-Cheng (TW)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/327,498

(22) Filed: Dec. 15, 2011

(30) Foreign Application Priority Data
Jul. 13, 2011 (CN) 201110195783.X

(51) Int. Cl. B32B 3/00; C08L 51/06; B32B 15/08; B32B 17/06; B32B 27/06

(52) U.S. Cl. 428/141; 428/458; 428/432; 428/461; 428/412; 428/463; 428/462; 524/504

(57) ABSTRACT

A resin composition used to being injection molded to metal to make composite of resin and metal, comprises 40% to 90% by weight of main resin, 5% to 30% by weight of crystallization modifier; and 0% to 40% by weight of filler. The main resin comprises one or more ingredients selected from a group consisting of polyethylene terephthalate and derivatives of polyethylene terephthalate. The resin composition has a low the crystallization temperature and an appropriate crystallization rate.

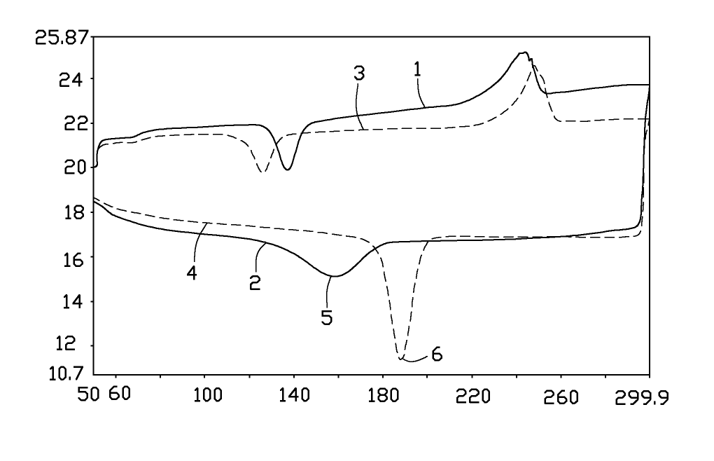

### CROSS-REFERENCE TO RELATED APPLICATIONS

This application is one of the three related co-pending U.S. patent applications listed below. All listed applications have the same assignee. The disclosure of each of the listed applications is incorporated by reference into all the other listed applications.

| Attorney | | |
|---|---|---|
| Docket No. | Title | Inventors |
| US 40743 | RESIN COMPOSITION AND | HSIN-PEI CHANG |
| | COMPOSITE MADE BY SAME | et al. |
| US 41138 | RESIN COMPOSITION AND | HSIN-PEI CHANG |
| | COMPOSITE MADE BY SAME | et al. |
| US 41139 | RESIN COMPOSITION AND | HSIN-PEI CHANG |
| | COMPOSITE MADE BY SAME | et al. |

### BACKGROUND

1. Technical Field

The present disclosure relates to a resin composition and a composite of resin and metal made by the resin composition.

2. Description of Related Art

To make a composite of metal and resin, a metal is first surface treated to form recesses on its surface. Then a thermoplastic resin composition is injected to the treated metal surface by injection molding and integrally bonds to the metal. The thermoplastic resin composition often contains polyphenylene sulfide (PPS) or polybutylene terephthalate (PBT) as a main component.

However, PPS resin composition can decompose into sulfurous acid during the molding process, which damages the injection molding machine. Also, during the molding process, molten PBT resin composition usually crystallizes before it fills the recesses of the metal due to its high crystallization rate, which makes a weak bond between resin and metal.

Therefore, there is room for improvement within the art.

### BRIEF DESCRIPTION OF THE FIGURE

Figure is a graph showing differential scanning calorimetry (DSC) curves of an exemplary resin composition and a contrastive resin composition.

### DETAILED DESCRIPTION

A resin composition according to an exemplary embodiment includes a main resin, a crystallization modifier and a filler. The mass percentage of the main resin is about 40% to 90%, the mass percentage of crystallization modifier is about 5% to 30%, and the mass percentage of filler is about 0% to 40%.

The main resin comprises one or more ingredients selected from a group consisting of polyethylene terephathalate (PET) and derivatives of PET.

The derivative of PET may be glycol-modified polyethylene terephathalate (PETG) or acid-modified polyethylene terephathalate (PETA).

The crystallization modifier comprises one or more ingredients selected from a group consisting of polyester, polyolefin, styrene polymers, and polyamide. The crystallization modifier slows down the crystallization rate of the molten PET resin and its derivatives at high temperatures, and further makes the resin composition crystallize at lower temperatures. Thus the resin composition crystallizes until it fills the recesses of the metal.

The polyester comprises one or more ingredients selected from a group consisting of polybutylene terephthalate (PBT), derivatives of PBT, polycarbonate (PC), derivatives of PC, polymethylmethacrylate (PMMA), and derivatives of PMMA.

The polyolefin comprises one or more ingredients selected from a group consisting of polypropylene (PP), polyethylene (PE), and graft-modified PE, such as maleic anhydride grafted polypropylene, and ethylene-acrylate-maleic anhydride.

The styrene polymer comprises one or more ingredients selected from a group consisting of polystyrene (PS), acrylonitrile-butadient-styrene (ABS), styrene-butadiene-styrene (SBS), and styrene-ethylene/butylene-styrene (SEBS).

The polyamide comprises one or more ingredients selected from a group consisting of aliphatic polyamide, aromatic polyamide, and polymers bonded by aliphatic polyamide and aromatic polyamide, such as polyamide-6, polyamide-66, polyamide-46.

The filler enhances the strength of the resin composition and reduces the linear expansion coefficient of the resin composition, making the value of linear expansion coefficient of the metal closer to that of the resin composition. The filler comprises at least one ingredient selected from a group consisting of glass fiber, carbon fiber, aramid fiber, calcium carbonate, magnesium carbonate, titanium dioxide, silica, talc, clay, and glass powder.

The resin composition may be directly molded to the treated surface of the metal by injection molding to form a composite of metal and resin. The metal may be made of aluminum alloy, titanium alloy, copper alloy, magnesium alloy or steel alloy. The metal has an ultra-fine irregular surface after being surface treated. The bond between the metal and the resin composition is substantially stronger when the metal has a plurality of recesses with diameter of about 10 nm to 1 μm on the surface.

### EXAMPLE

In the embodiment, a resin composition 10 was prepared. The resin composition 10 included 60 wt % of PET, 5 wt % of PETG, 5 wt % of maleic anhydride-grafted PP and 30 wt % of glass fiber.

For comparison, another resin composition 20 was provided. The resin composition 20 included 70 wt % of PET and 30 wt % of glass fiber.

(1) Thermal Analysis

The figure shows the DSC curves of the resin composition 10 and the resin composition 20. The abscissa axis indicates temperature (unit/° C.), the vertical axis indicates heat (unit/mW) and upwards the vertical axis indicates endothermic. The curve 1 and curve 2 represent endothermic curve and exothermic curve of the resin composition 10, respectively. The curve 3 and curve 4 represent endothermic curve and exothermic curve of the resin composition 20, respectively. The curve 1 and curve 3 represent temperature rising from 50° C. to 300° C. at an elevation rate of 10° C./min, and the curve 2 and curve 4 represent temperature dropping from 300° C. to 50° C. at a cooling rate of 20° C./min.

The exothermic peak 5 and exothermic peak 6 are crystallization peaks. The exothermic peak 5 is broader and moves towards the lower temperature in comparison to the exothermic peak 6. This indicates that both the crystallization temperature and the crystallization rate of the resin composition 10 are reduced, which is beneficial for improving the bond between the metal and resin composition.

(2) Shearing Strength Test

The resin composition 10 and resin composition 20 were molded to the same aluminum plate by injection molding to form a composite A and a composite B, respectively. The aluminum plate had been surface treated. Both the composite A and the composite B were annealed at 120° C. for 1 hour. Then the shearing strength between the aluminum plate and the resin composition 10 and 20 were tested. Shearing strength between the resin composition 10 and the aluminum plate was 24 MPa, and shearing strength between the resin composition 20 and the aluminum plate was 11 MPa. Thus, the bond between the resin composition 10 and the metal was substantially stronger than the bond between the resin composition 20 and the metal.

The resin composition in this disclosure has a low crystallization temperature and appropriate crystallization rate. The bond between the resin composition and metal is stronger. The resin composition contains no sulfur and does not damage the mold.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

1. A resin composition, comprising:
about 40% to 90% by weight of a main resin, the main resin comprising one or more ingredients selected from a group consisting of polyethylene terephthalate and derivatives of polyethylene terephthalate;
about 5% to 30% by weight of a crystallization modifier, the crystallization modifier comprising one or more ingredients selected from a group consisting of polyester, polyolefin, and styrene polymer; and
about 0% to 40% by weight of a filler.

2. The resin composition as claimed in claim 1, wherein the derivative of polyethylene terephthalate is glycol-modified polyethylene terephthalate or acid-modified polyethylene terephthalate.

3. The resin composition as claimed in claim 1, wherein the filler comprises at least one selected from a group consisting of glass fiber, carbon fiber, aramid fiber, calcium carbonate, magnesium carbonate, titanium dioxide, silica, talc, clay, and glass powder.

4. (canceled)

5. The resin composition as claimed in claim 1, wherein the polyester comprises one or more ingredients selected from a group consisting of polybutylene terephthalate, derivatives of polybutylene terephthalate, polycarbonate, derivatives of polycarbonate, polymethylmethacrylate, and derivatives of polymethylmethacrylate.

6. The resin composition as claimed in claim 1, wherein the polyolefin comprises one or more ingredients selected from a group consisting of polypropylene, polyethylene, and graft-modified polyethylene.

7. The resin composition as claimed in claim 1, wherein the styrene polymer comprises one or more ingredients selected from a group consisting of polystyrene, acrylonitrile butadient styrene, styrene-butadiene-styrene, and styrene-ethylene/butylene-styrene.

8. (canceled)

9. A composite of metal and resin, comprising:
a metal substrate, and
a resin object formed on the metal substrate by injection molding, the resin object being made of a resin composition,
wherein the resin composition comprises:
about 40% to 90% by weight of a main resin, the main resin comprising one or more ingredients selected from a group consisting of polyethylene terephthalate and derivatives of polyethylene terephthalate;
about 5% to 30% by weight of a crystallization modifier, the crystallization modifier comprising one or more ingredients selected from a group consisting of polyester, polyolefin, and styrene polymer; and
about 0% to 40% by weight of a filler.

10. The composite of metal and resin as claimed in claim 9, wherein the metal substrate is made of aluminum alloy, titanium alloy, copper alloy, magnesium alloy or steel alloy.

11. The composite of metal and resin as claimed in claim 9, wherein there is a plurality of recesses on the surface of the metal substrate, the recesses having diameters of about 10 nm to 1 μm.

12. The composite of metal and resin as claimed in claim 9, wherein the filler comprises at least one selected from a group consisting of glass fiber, carbon fiber, aramid fiber, calcium carbonate, magnesium carbonate, titanium dioxide, silica, talc, clay, and glass powder.

13. (canceled)

14. The composite of metal and resin as claimed in claim 9, wherein the polyester comprises one or more ingredients selected from a group consisting of polybutylene terephthalate, derivatives of polybutylene terephthalate, polycarbonate and derivatives of polycarbonate, polymethylmethacrylate, and derivatives of polymethylmethacrylate.

15. The composite of metal and resin as claimed in claim 9, wherein the polyolefin comprises one or more ingredients selected from a group consisting of polypropylene, polyethylene and graft-modified polyethylene.

16. The composite of metal and resin as claimed in claim 9, wherein the styrene polymer comprises one or more ingredients selected from a group consisting of polystyrene, acrylonitrile butadient styrene, styrene-butadiene-styrene, and styrene-ethylene/butylene-styrene.

17. (canceled)
